(19) United States
(12) Patent Application Publication
(10) Pub. No.: US 2022/0027187 A1
(43) Pub. Date: Jan. 27, 2022

(54) SUPPORTING CLONES WITH CONSOLIDATED SNAPSHOTS

(71) Applicant: VMware, Inc., Palo Alto, CA (US)

(72) Inventors: Wenguang Wang, Palo Alto, CA (US); Matt Amdur, Palo Alto, CA (US); Vamsi Gunturu, Palo Alto, CA (US); Eric Knauft, Palo Alto, CA (US); Pascal Renauld, Palo Alto, CA (US); Blake Lewis, Palo Alto, CA (US); Peng Mi, Palo Alto, CA (US)

(73) Assignee: VMware, Inc., Palo Alto, CA (US)

(21) Appl. No.: 16/937,780

(22) Filed: Jul. 24, 2020

(51) Int. Cl. G06F 9/455; G06F 16/11; G06F 16/901

(52) U.S. Cl. CPC G06F 9/45558; G06F 16/128; G06F 2009/45575; G06F 2009/45562; G06F 2009/4557; G06F 16/9024

(57) ABSTRACT

The present disclosure is related to methods, systems, and machine-readable media for supporting clones with consolidated snapshots. A clone of a virtual computing instance can be created in a snapshot tree provided by a software defined data center. A consolidated snapshot including tuples from a diskchain of the clone in the snapshot tree can be created responsive to a determination that the snapshot tree exceeds a threshold.

### BACKGROUND

A data center is a facility that houses servers, data storage devices, and/or other associated components such as backup power supplies, redundant data communications connections, environmental controls such as air conditioning and/or fire suppression, and/or various security systems. A data center may be maintained by an information technology (IT) service provider. An enterprise may purchase data storage and/or data processing services from the provider in order to run applications that handle the enterprises' core business and operational data. The applications may be proprietary and used exclusively by the enterprise or made available through a network for anyone to access and use.

Virtual computing instances (VCIs) have been introduced to lower data center capital investment in facilities and operational expenses and reduce energy consumption. A VCI is a software implementation of a computer that executes application software analogously to a physical computer. VCIs have the advantage of not being bound to physical resources, which allows VCIs to be moved around and scaled to meet changing demands of an enterprise without affecting the use of the enterprise's applications. In a software defined data center, storage resources may be allocated to VCIs in various ways, such as through network attached storage (NAS), a storage area network (SAN) such as fiber channel and/or Internet small computer system interface (iSCSI), a virtual SAN, and/or raw device mappings, among others.

Snapshots and clones may be utilized in a software defined data center to provide backups and/or disaster recovery. In some instances, as clones are created over time a chain of clones may deepen to such an extent that performance degrades during reads.

### BRIEF DESCRIPTION OF THE DRAWINGS

FIG. 1 is a diagram of a host and a system for supporting clones with consolidated snapshots according to one or more embodiments of the present disclosure.

FIG. 2A is a diagram of an example snapshot tree according to one or more embodiments of the present disclosure.

FIG. 2B is a diagram of the example snapshot tree after the creation of a consolidated snapshot according to one or more embodiments of the present disclosure.

FIG. 3 is a diagram of a system for supporting clones with consolidated snapshots according to one or more embodiments of the present disclosure.

FIG. 4 is a diagram of a machine for supporting clones with consolidated snapshots according to one or more embodiments of the present disclosure.

FIG. 5 is a flow chart illustrating one or more methods for supporting clones with consolidated snapshots according to one or more embodiments of the present disclosure.

FIG. 6 is a flow chart illustrating one or more methods for supporting clones with consolidated snapshots according to one or more embodiments of the present disclosure.

### DETAILED DESCRIPTION

The term “virtual computing instance” (VCI) refers generally to an isolated user space instance, which can be executed within a virtualized environment. Other technologies aside from hardware virtualization can provide isolated user space instances, also referred to as data compute nodes. Data compute nodes may include non-virtualized physical hosts, VCIs, containers that run on top of a host operating system without a hypervisor or separate operating system, and/or hypervisor kernel network interface modules, among others. Hypervisor kernel network interface modules are non-VCI data compute nodes that include a network stack with a hypervisor kernel network interface and receive/transmit threads.

VCIs, in some embodiments, operate with their own guest operating systems on a host using resources of the host virtualized by virtualization software (e.g., a hypervisor, virtual machine monitor, etc.). The tenant (i.e., the owner of the VCI) can choose which applications to operate on top of the guest operating system. Some containers, on the other hand, are constructs that run on top of a host operating system without the need for a hypervisor or separate guest operating system. The host operating system can use name spaces to isolate the containers from each other and therefore can provide operating-system level segregation of the different groups of applications that operate within different containers. This segregation is akin to the VCI segregation that may be offered in hypervisor-virtualized environments that virtualize system hardware, and thus can be viewed as a form of virtualization that isolates different groups of applications that operate in different containers. Such containers may be more lightweight than VCIs.

While the specification refers generally to VCIs, the examples given could be any type of data compute node, including physical hosts, VCIs, non-VCI containers, and hypervisor kernel network interface modules. Embodiments of the present disclosure can include combinations of different types of data compute nodes.

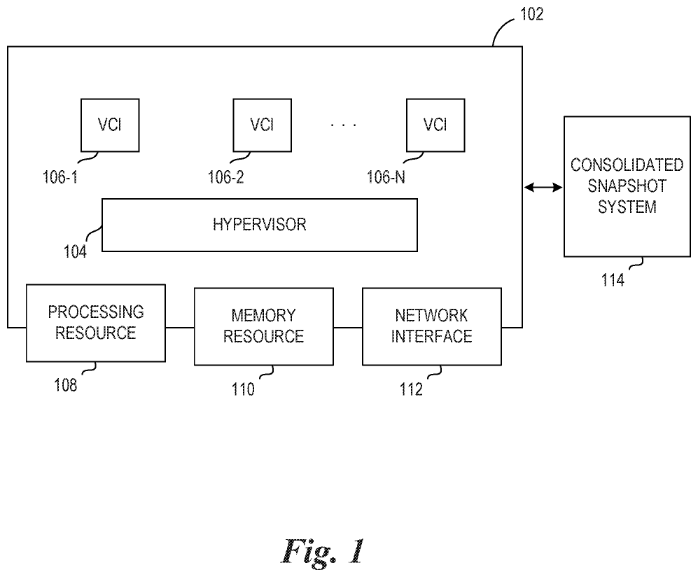

As used herein with respect to VCIs, a “disk” is a representation of memory resources (e.g., memory resources 110 illustrated in FIG. 1) that are used by a VCI. As used herein, “memory resource” includes primary storage (e.g., cache memory, registers, and/or main memory such as random access memory (RAM)) and secondary or other storage (e.g., mass storage such as hard drives, solid state drives, removable media, etc., which may include non-volatile memory). The term “disk” does not imply a single physical memory device. Rather, “disk” implies a portion of memory resources that are being used by a VCI, regardless of how many physical devices provide the memory resources.

A VCI snapshot (referred to herein simply as “snapshot”) can preserve the state of a VCI so that it can be reverted to at a later point in time. The snapshot can include memory as well. In some embodiments, a snapshot includes secondary storage, while primary storage is optionally included with the snapshot. A snapshot can store changes from a parent snapshot (e.g., without storing an entire copy of the parent snapshot). A clone VCI (referred to herein simply as “clone”) is a copy of an existing VCI. A clone can be created from a snapshot. A clone can start a chain of snapshots.

As referred to herein, a snapshot tree can be represented as a tree of disks and can include both snapshots and clones. The snapshot tree can become complex as the clone levels increase (e.g., the quantity of clones increases), and supporting clones may become computationally expensive as the snapshot tree grows. As previously discussed, a snapshot stores only changes from a previous snapshot rather than an entire copy of the previous snapshot. Thus, each snapshot may have its own unique logical map that includes tuples mapping logical block addresses to physical block addresses. An example tuple may be “L10→P100, N20,” where a logical block address, L10, maps to a physical block address, P100, with a total number of blocks, N20. Because snapshots store only changes, if a logical address was not written in a given snapshot, its logical map may make no reference to it.

In operation, then, when reading a particular logical address, the current snapshot is initially consulted. If, however, the particular address to be read was never written in the current snapshot, the chain of the current snapshot is consulted in reverse chronological order beginning with the snapshot previous to the current snapshot. If the particular address to be read was never written in any snapshots of the current snapshot chain, a snapshot (or snapshot chain) at a higher level in the snapshot tree would be consulted next. This path from the current snapshot, through its previous snapshots, to a root node (snapshot) of the tree can be referred to as a “diskchain.” In an example snapshot tree with 10 levels of clones, it may take up to 10 lookups to find a desired tuple. The performance of deeper chains such as this may be undesirably slow.

Embodiments of the present disclosure can address these issues through the creation of a particular kind of snapshot, which is referred to herein as a “consolidated snapshot,” for certain clones. A consolidated snapshot is placed at the beginning of a snapshot chain and includes tuples (e.g., all tuples) in its diskchain. In some embodiments, any read will complete at a consolidated snapshot without requiring consultation of snapshots or snapshot chains at higher levels in the diskchain because the consolidated snapshot includes all tuples from all previous snapshots in the diskchain.

A consolidated snapshot can bound the number of lookups used to find a desired tuple, even in deep chains. As a result, performance degradation resulting from deep diskchain lookups can be diminished. Consolidated snapshots can be created in the background without affecting regular input/output and can be put into effect when their creation is complete. Consolidated snapshots may be created in multiple circumstances. In some embodiments, a consolidated snapshot is created when a threshold clone depth (e.g., 10 clones) is reached. In some embodiments, a consolidated snapshot is created when read requests associated with a clone generate a threshold quantity, or proportion, of reads to previous clones in the diskchain (e.g., reads to “old” data). In such embodiments, a consolidated snapshot may be created even if a threshold clone depth has not yet been reached. The trigger(s) for the creation of consolidated snapshots may be configurable. The trigger(s) for the creation of consolidated snapshots may depend on system operating parameters, such as central processing unit (CPU) speed, frequency of read requests, locality of read data, and/or performance requirements, for instance.

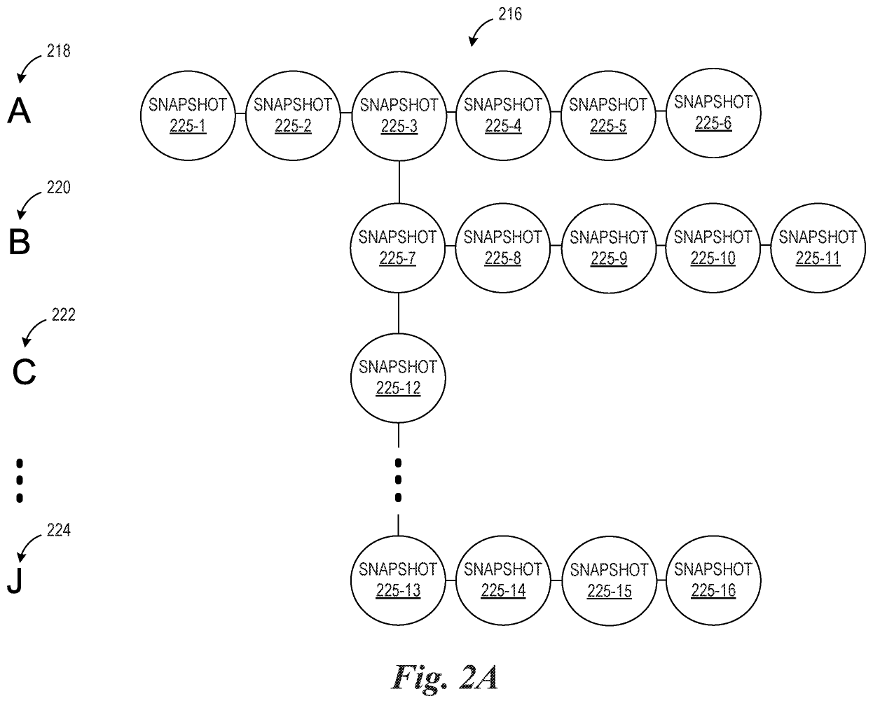

The figures herein follow a numbering convention in which the first digit or digits correspond to the drawing figure number and the remaining digits identify an element or component in the drawing. Similar elements or components between different figures may be identified by the use of similar digits. For example, 114 may reference element “14” in FIG. 1, and a similar element may be referenced as 214 in FIG. 2. As will be appreciated, elements shown in the various embodiments herein can be added, exchanged, and/or eliminated so as to provide a number of additional embodiments of the present disclosure. In addition, as will be appreciated, the proportion and the relative scale of the elements provided in the figures are intended to illustrate certain embodiments of the present invention, and should not be taken in a limiting sense.

FIG. 1 is a diagram of a host and a system for supporting clones with consolidated snapshots according to one or more embodiments of the present disclosure. The system can include a host 102 with processing resources 108 (e.g., a number of processors), memory resources 110, and/or a network interface 112. The host 102 can be included in a software defined data center. A software defined data center can extend virtualization concepts such as abstraction, pooling, and automation to data center resources and services to provide information technology as a service (ITaaS). In a software defined data center, infrastructure, such as networking, processing, and security, can be virtualized and delivered as a service. A software defined data center can include software defined networking and/or software defined storage. In some embodiments, components of a software defined data center can be provisioned, operated, and/or managed through an application programming interface (API).

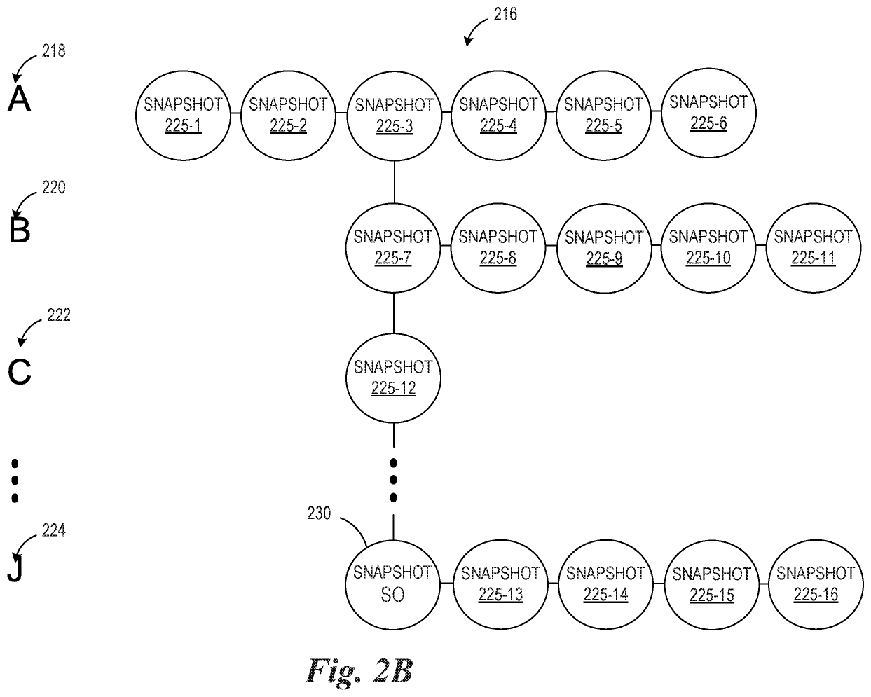

The host 102 can incorporate a hypervisor 104 that can execute a number of virtual computing instances 106-1, 106-2, . . . , 106-N (referred to generally herein as “VCIs 106”). The VCIs can be provisioned with processing resources 108 and/or memory resources 110 and can communicate via the network interface 112. The processing resources 108 and the memory resources 110 provisioned to the VCIs can be local and/or remote to the host 102. For example, in a software defined data center, the VCIs 106 can be provisioned with resources that are generally available to the software defined data center and not tied to any particular hardware device. By way of example, the memory resources 110 can include volatile and/or non-volatile memory available to the VCIs 106. The VCIs 106 can be moved to different hosts (not specifically illustrated), such that a different hypervisor manages the VCIs 106. The host 102 can be in communication with a consolidated snapshot system 114. An example of the consolidated snapshot system is illustrated and described in more detail with respect to FIG. 3. In some embodiments, the consolidated snapshot system 114 can be a server, such as a web server.

FIG. 2A is a diagram of an example snapshot tree 216 according to one or more embodiments of the present disclosure. FIG. 2B is a diagram of the example snapshot tree 216 after the creation of a consolidated snapshot according to one or more embodiments of the present disclosure. FIGS. 2A and 2B may be cumulatively referred to herein as “FIG. 2.”

As shown in the example illustrated in FIG. 2, the tree 216 includes a plurality of vertical levels which correspond to clones of a VCI. The tree 216 includes a base (e.g., root) level A 218, a clone B 220, a clone C 222, and a clone J 224. As previously discussed, a clone can include a snapshot or a chain of snapshots. In the example illustrated in FIG. 2, the base level A 218 includes a root 225-1 (e.g., the initial instance of the VCI), in a snapshot chain comprising snapshots 225-2, 225-3, 225-4, 225-5, and 225-6 (referred to herein as snapshots 2, 3, 4, 5, and 6, respectively). The clone B 220 includes a snapshot chain comprising snapshots 225-7, 225-8, 225-9, 225-10, and 225-11 (referred to herein as snapshots 7, 8, 9, 10, and 11, respectively). The clone C 222 includes a snapshot 225-12 (referred to herein as snapshot 12). The clone J includes a snapshot chain comprising snapshots 225-13, 225-14, 225-15, and 225-16 (referred to herein as snapshots 13, 14, 15, and 16, respectively). In the example illustrated in FIG. 2, the snapshot 16 is a current (e.g., live) snapshot of clone J. Snapshot 16 can have a diskchain, which is a path from a snapshot 16 to root 225-1). A diskchain for snapshot 16 is 16-15-14-13- . . . -12-8-7-3-2-1. Snapshots 4, 5, and 6 from clone A are not included in the diskchain for snapshot 16. Snapshots 9, 10, and 11 from clone B are also not included in the diskchain for snapshot 16.

When the tree 216 exceeds a threshold, a consolidated snapshot 230 (labeled “s0” in FIG. 2B) can be created. In some embodiments, the tree is determined to exceed the threshold based on the operation of the tree (discussed further below). In some embodiments, the tree is determined to exceed the threshold based on the structure of the tree. For instance, the tree can be determined to exceed the threshold when the creation of a clone causes the tree to have a clone depth that exceeds the threshold. Clone depth, as referred to herein, is a quantity of clones (levels) in a diskchain. Referring to the example illustrated in FIG. 2, the creation of the clone J (e.g., cloning snapshot 225-12) gives the tree 216 a depth of 10 levels. If the threshold is 10 levels, for instance, the creation of clone J can cause the creation of the consolidated snapshot 230. It is noted that while a threshold depth of 10 may be occasionally referred to herein, such reference is made for purposes of illustration and is not to be taken in a limiting sense. Embodiments of the present disclosure do not limit a depth threshold to a particular quantity of levels. The threshold can be determined based on system operating parameters, for instance, including a speed of a processing resource configured to execute the VCI, a frequency of read requests, a locality of read data, and/or performance requirements of the VCI.

As shown in FIG. 2B, the consolidated snapshot 230 can be placed at the beginning of the snapshot chain of the clone J. Accordingly, the snapshot chain of the clone J, which previously was 16-15-14-13- . . . -12-8-7-3-2-1, becomes 16-15-14-13-s0- . . . -12-8-7-3-2-1 after the creation of the consolidated snapshot S0. It is noted that a tuple corresponding to a first snapshot in a snapshot chain typically includes a snapshot identifier (ID) of 1 (e.g., “s1”), a tuple corresponding to a second snapshot in a snapshot chain typically includes a snapshot ID of 2 (e.g., “s2”), and so on. In some embodiments, a tuple corresponding to the consolidated snapshot includes a zeroth snapshot ID (e.g., “s0”).

The consolidated snapshot can be stored as metadata associated with the storage of other data corresponding to the clone for which the consolidated snapshot is created. The consolidated snapshot 230 can include information of each logical map from the snapshots in the diskchain of clone J. The consolidated snapshot 230 can include tuples from the diskchain of the clone J. In some embodiments, the consolidated snapshot 230 includes all tuples from the diskchain of the clone J. Stated differently, the consolidated snapshot 230 can include tuples from each of snapshots 12, 8, 7, 3, 2, 1. The consolidated snapshot S0 can be created in a background process without affecting input/output operations of the software defined data center and/or the corresponding VCI.

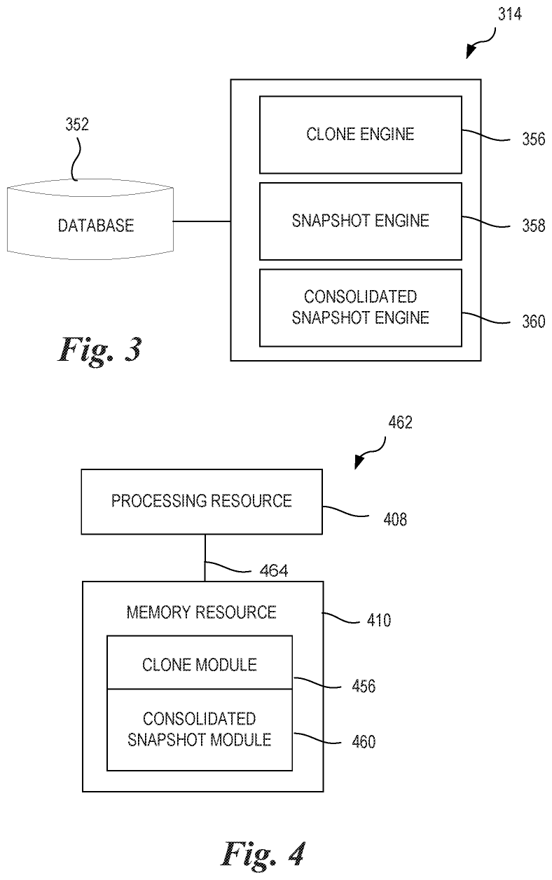

FIG. 3 is a diagram of a system 314 for supporting clones with consolidated snapshots according to one or more embodiments of the present disclosure. The system 314 can include a database 352, a subsystem 354, and/or a number of engines, for example clone engine 356, snapshot engine 358, and/or consolidated snapshot engine 360, and can be in communication with the database 352 via a communication link. The system 314 can include additional or fewer engines than illustrated to perform the various functions described herein. The system can represent program instructions and/or hardware of a machine (e.g., machine 462 as referenced in FIG. 4, etc.). As used herein, an “engine” can include program instructions and/or hardware, but at least includes hardware. Hardware is a physical component of a machine that enables it to perform a function. Examples of hardware can include a processing resource, a memory resource, a logic gate, an application specific integrated circuit, a field programmable gate array, etc.

The number of engines can include a combination of hardware and program instructions that is configured to perform a number of functions described herein. The program instructions (e.g., software, firmware, etc.) can be stored in a memory resource (e.g., machine-readable medium) and/or can be provided as hard-wired program instructions (e.g., logic). Hard-wired program instructions can be considered as both program instructions and hardware.

In some embodiments, the clone engine 356 can include a combination of hardware and program instructions that is configured to create a clone of a VCI in a snapshot tree provided by a software defined data center. In some embodiments, the snapshot engine 358 can include a combination of hardware and program instructions that is configured to take a snapshot of the clone. In some embodiments, the consolidated snapshot engine 360 can include a combination of hardware and program instructions that is configured to create a consolidated snapshot including tuples from a diskchain of the clone in the snapshot tree responsive to a determination that the snapshot tree exceeds a threshold.

The creation of the consolidated snapshot can be carried out by issuing a read request (e.g., a “dummy” read request) in order to receive a logical-to-physical address mapping of all tuples from the diskchain. For instance, the consolidated snapshot engine 360 can be configured to issue a read request for a current logical address and a number of addresses (e.g., a number of blocks) corresponding to the VCI and receive, responsive to the read request, a logical-to-physical address mapping associated with the VCI, wherein the logical-to-physical address mapping includes all tuples from the diskchain of the clone. In some embodiments, the consolidated snapshot engine 360 can include a combination of hardware and program instructions that is configured to add the consolidated snapshot to the snapshot tree in a snapshot chain of the clone ahead of the snapshot of the clone.

In some embodiments, the snapshot engine 358 can include a combination of hardware and program instructions that is configured to subsequently take a plurality of snapshots, wherein each of the plurality of snapshots is a snapshot of the clone at a respective time instance, and the consolidated snapshot engine 360 can include a combination of hardware and program instructions that is configured to add the consolidated snapshot to a beginning of a snapshot chain of the clone that includes the snapshot of the clone and the plurality of snapshots.

Though not specifically shown in FIG. 3, some embodiments can include a read engine having a combination of hardware and program instructions that is configured to receive a read request for a logical address corresponding to the VCI after the creation of the consolidated snapshot and read the logical address search the consolidated snapshot for a tuple corresponding to the logical address if the logical address was not written in the snapshot of the clone.

FIG. 4 is a diagram of a machine for supporting clones with consolidated snapshots according to one or more embodiments of the present disclosure. The machine 462 can utilize software, hardware, firmware, and/or logic to perform a number of functions. The machine 462 can be a combination of hardware and program instructions configured to perform a number of functions (e.g., actions). The hardware, for example, can include a number of processing resources 408 and a number of memory resources 410, such as a machine-readable medium (MRM) or other memory resources 410. The memory resources 410 can be internal and/or external to the machine 462 (e.g., the machine 462 can include internal memory resources and have access to external memory resources). In some embodiments, the machine 462 can be a VCI. The program instructions (e.g., machine-readable instructions (MRI)) can include instructions stored on the MRM to implement a particular function (e.g., an action such as creating a consolidated snapshot, as described herein). The set of MRI can be executable by one or more of the processing resources 408. The memory resources 410 can be coupled to the machine 462 in a wired and/or wireless manner. For example, the memory resources 410 can be an internal memory, a portable memory, a portable disk, and/or a memory associated with another resource, e.g., enabling MRI to be transferred and/or executed across a network such as the Internet. As used herein, a “module” can include program instructions and/or hardware, but at least includes program instructions.

Memory resources 410 can be non-transitory and can include volatile and/or non-volatile memory. Volatile memory can include memory that depends upon power to store information, such as various types of dynamic random access memory (DRAM) among others. Non-volatile memory can include memory that does not depend upon power to store information. Examples of non-volatile memory can include solid state media such as flash memory, electrically erasable programmable read-only memory (EEPROM), phase change memory (PCM), 3D cross-point, ferroelectric transistor random access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, magnetic memory, optical memory, and/or a solid state drive (SSD), Non-Volatile Memory Express (NVMe) device, etc., as well as other types of machine-readable media.

The processing resources 408 can be coupled to the memory resources 410 via a communication path 464. The communication path 464 can be local or remote to the machine 462. Examples of a local communication path 464 can include an electronic bus internal to a machine, where the memory resources 410 are in communication with the processing resources 408 via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof. The communication path 464 can be such that the memory resources 410 are remote from the processing resources 408, such as in a network connection between the memory resources 410 and the processing resources 408. That is, the communication path 464 can be a network connection. Examples of such a network connection can include a local area network (LAN), wide area network (WAN), personal area network (PAN), and the Internet, among others.

As shown in FIG. 4, the MRI stored in the memory resources 410 can be segmented into a number of modules 456, 460 that when executed by the processing resources 408 can perform a number of functions. As used herein a module includes a set of instructions included to perform a particular task or action. The number of modules 456, 460 can be sub-modules of other modules. For example, the clone module 456 can be a sub-module of the consolidated snapshot module 460 and/or can be contained within a single module. Furthermore, the number of modules 456, 460 can comprise individual modules separate and distinct from one another. Examples are not limited to the specific modules 456, 460 illustrated in FIG. 4.

Each of the number of modules 456, 460 can include program instructions and/or a combination of hardware and program instructions that, when executed by a processing resource 408, can function as a corresponding engine as described with respect to FIG. 3. For example, the clone module 456 can include program instructions and/or a combination of hardware and program instructions that, when executed by a processing resource 408, can function as the clone engine 356, though embodiments of the present disclosure are not so limited. The consolidated snapshot module 460 can include program instructions and/or a combination of hardware and program instructions that, when executed by a processing resource 408, can function as the consolidated snapshot engine 360.

The machine 462 can include a clone module 456, which can include instructions to create a clone of a VCI in a snapshot tree provided by a software defined data center. The machine 462 can include a consolidated snapshot module 456, which can include instructions to create the consolidated snapshot including all tuples from the diskchain of the clone in the snapshot tree.

An example of executable instructions to create the consolidated snapshot is:

curLBA = 0;
while (curLba < Max) {

get a list of “LBA −> <PBA, numBlks>” by issuing a dummy

read request from curLba to curLba + numBlks

--no data is read, only PBA is obtained
append consolidated snapshot to the list of mappings returned:
--e.g., “LBA, Snap0 −> <PBA, numBlks>”
curLba += numBlks;

}

The consolidated snapshot module 456 can include instructions to determine that the snapshot tree exceeds the threshold, including instructions to determine that the creation of the clone caused the snapshot tree to have a clone depth that exceeds the threshold. The consolidated snapshot module 456 can include instructions to determine that the snapshot tree exceeds the threshold, including instructions to count read requests associated with the clone that cause ascension through the diskchain in order to satisfy the read requests and determine that the count exceeds the threshold.

In some embodiments, a threshold, as described herein, can be set and/or determined based on a speed of a processing resource configured to execute the VCI. In some embodiments, a threshold, as described herein, can be set and/or determined based on a quantity of reads of the tuples from the diskchain of the clone. In some embodiments, a threshold, as described herein, can be set and/or determined based on a performance target associated with the software defined data center. In some embodiments, a threshold, as described herein, can be set and/or determined based on a locality of the tuples from the diskchain of the clone.

The consolidated snapshot module 456 can include instructions to receive a read request for a logical address corresponding to the VCI after the creation of the consolidated snapshot and search the consolidated snapshot for a tuple corresponding to the logical address responsive to a determination that the logical address is not in any snapshots of a snapshot chain of the clone.

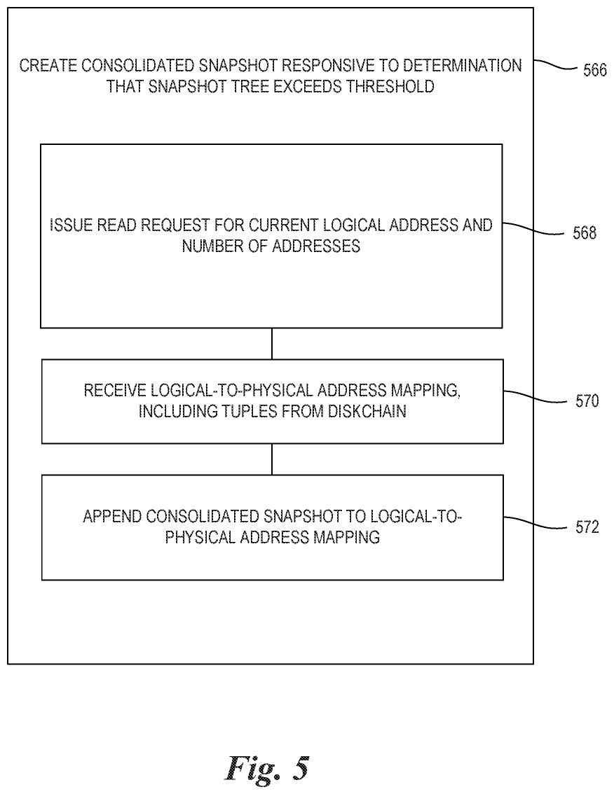

FIG. 5 is a flow chart illustrating one or more methods for supporting clones with consolidated snapshots according to one or more embodiments of the present disclosure. At 566 the method can include creating a consolidated snapshot including tuples from a diskchain of a clone of a VCI in a snapshot tree responsive to a determination that the snapshot tree exceeds a threshold. At 568, creating the consolidated snapshot can include issuing a read request for a current logical address and a number of addresses corresponding to the VCI. At 570, creating the consolidated snapshot can include receiving, responsive to the read request, a logical-to-physical address mapping associated with the VCI, wherein the logical-to-physical address mapping includes tuples from the diskchain of the clone in the snapshot tree. At 572, creating the consolidated snapshot can include appending the consolidated snapshot to the logical-to-physical address mapping.

In some embodiments, a method for supporting clones with consolidated snapshots can include adding the consolidated snapshot to a beginning of a snapshot chain of the clone that includes the snapshot of the clone. As shown in the example previously discussed in connection with FIG. 2, the snapshot S0 is added to a chain that had previously comprised S9-S10-S11-S12. In some embodiments, a method for supporting clones with consolidated snapshots can include assigning a zeroth snapshot identifier (e.g., “s0”) to the consolidated snapshot as a minor key.

In some embodiments, a method for supporting clones with consolidated snapshots can include maintaining a clone table that associates each of the plurality of clones in the snapshot tree with a respective clone depth identifier. In some embodiments, such an identifier may be represented by the levels illustrated in FIG. 2 (e.g., “A,” “B,” etc.). In some embodiments, such an identifier may be a numerical identifier. In some embodiments, the clone table can associate each of the plurality of clones in the snapshot tree with a respective clone depth identifier and the parent clone and snapshot identifier that a clone is based on.

In some embodiments, a method for supporting clones with consolidated snapshots can include determining that the snapshot tree exceeds the threshold based on a value of the respective clone depth identifier associated with the clone exceeding the threshold. In some embodiments, the clone depth identifier can exceed the threshold if a numerical value of the clone depth identifier exceeds a numerical threshold. In some embodiments, the clone depth identifier can exceed the threshold if the clone depth identifier is determined to be a particular identifier (e.g., “J” in the example illustrated in FIG. 2).

In some embodiments, a method for supporting clones with consolidated snapshots can include using a counter to determine a quantity of read requests for a logical address corresponding to the VCI that cause ascension through the diskchain of the clone and determining that the snapshot tree exceeds the threshold based on the quantity of read requests exceeding the threshold. As previously discussed, exceeding the threshold may include read requests associated with a clone generating a threshold quantity of reads to previous clones in the diskchain (e.g., reads to “old” data).

In some embodiments, a method for supporting clones with consolidated snapshots can include creating a child clone of the clone before creating the consolidated snapshot, adding an indication of the child clone and a corresponding identifier of the child clone to the clone table before creating the consolidated snapshot, and modifying the identifier of the child clone in the clone table responsive to the creation of the consolidated snapshot. A child clone of a clone for which a consolidated snapshot was created can be updated in the clone table such that the threshold is “reset.” For example, if a consolidated snapshot is created for a clone at a tenth level, an identifier associated with its child clone that indicates an eleventh level can be modified to indicate a first level. Therefore, the count to a next threshold level can begin at the child clone.

In some embodiments, a method for supporting clones with consolidated snapshots can include receiving a read request for a logical address corresponding to the VCI subsequent to creating the clone and searching the consolidated snapshot for a tuple corresponding to the logical address if the logical address was not written in any snapshots of the snapshot chain of the clone. When a read request is received, embodiments herein search the current snapshot first. If the logical address was not written in the current snapshot, the previous snapshot can be searched. That process can continue towards the base of the tree until the consolidated snapshot is reached. Because the consolidated snapshot includes tuples from the diskchain (e.g., from the entire diskchain) the logical address can be read from the consolidated snapshot.

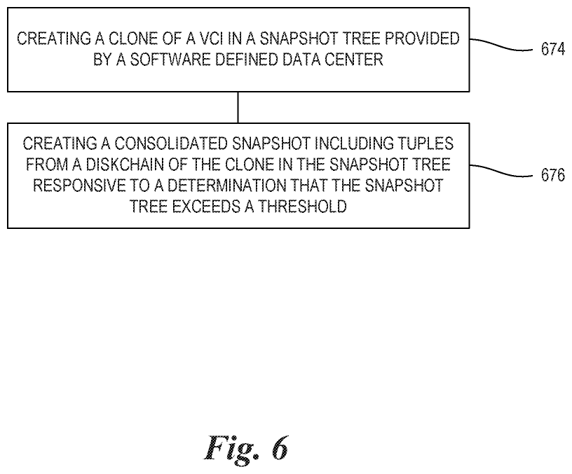

FIG. 6 is a flow chart illustrating one or more methods for supporting clones with consolidated snapshots according to one or more embodiments of the present disclosure. At 674, the method can include creating a clone of a virtual computing instance (VCI) in a snapshot tree provided by a software defined data center.

At 676, the method can include creating a consolidated snapshot including tuples from a diskchain of the clone in the snapshot tree responsive to a determination that the snapshot tree exceeds a threshold.

The present disclosure is not limited to particular devices or methods, which may vary. The terminology used herein is for the purpose of describing particular embodiments, and is not intended to be limiting. As used herein, the singular forms “a”, “an”, and “the” include singular and plural referents unless the content clearly dictates otherwise. Furthermore, the words “can” and “may” are used throughout this application in a permissive sense (i.e., having the potential to, being able to), not in a mandatory sense (i.e., must). The term “include,” and derivations thereof, mean “including, but not limited to.”

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Various advantages of the present disclosure have been described herein, but embodiments may provide some, all, or none of such advantages, or may provide other advantages.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method, comprising:
creating a clone of a virtual computing instance (VCI) in a snapshot tree provided by a software defined data center; and
creating a consolidated snapshot including tuples from a diskchain of the clone in the snapshot tree responsive to a determination that the snapshot tree exceeds a threshold.

2. The method of claim 1, wherein the method includes creating the consolidated snapshot including all tuples from the diskchain of the clone in the snapshot tree.

3. The method of claim 1, wherein determining that the snapshot tree exceeds the threshold includes determining that the creation of the clone caused the snapshot tree to have a clone depth that exceeds the threshold.

4. The method of claim 1, wherein the method includes:
maintaining a clone table that associates each of a plurality of clones in the snapshot tree with a respective clone depth identifier; and
determining that the snapshot tree exceeds the threshold based on a value of the respective clone depth identifier associated with the clone exceeding the threshold.

5. The method of claim 1, wherein determining that the snapshot tree exceeds the threshold includes:
counting read requests associated with the clone that cause ascension through the diskchain in order to satisfy the read requests; and
determining that the count exceeds the threshold.

6. The method of claim 1, wherein creating the consolidated snapshot includes:
issuing a read request for a current logical address and a number of addresses corresponding to the VCI;
receiving, responsive to the read request, a logical-to-physical address mapping associated with the VCI, wherein the logical-to-physical address mapping includes tuples from the diskchain of the clone in the snapshot tree; and
appending the consolidated snapshot to the logical-to-physical address mapping.

7. The method of claim 1, wherein the method includes:
receiving a read request for a logical address corresponding to the VCI after the creation of the consolidated snapshot; and
searching the consolidated snapshot for a tuple corresponding to the logical address responsive to a determination that the logical address is not in any snapshots of a snapshot chain of the clone.

8. A non-transitory machine-readable medium having instructions stored thereon which, when executed by a processor, cause the processor to:
create a clone of a virtual computing instance (VCI) in a snapshot tree provided by a software defined data center; and
create a consolidated snapshot including tuples from a diskchain of the clone in the snapshot tree responsive to a determination that the snapshot tree exceeds a threshold.

9. The medium of claim 8, including instructions to create the consolidated snapshot including all tuples from the diskchain of the clone in the snapshot tree.

10. The medium of claim 1, wherein the instructions to determine that the snapshot tree exceeds the threshold comprise instructions to determine that the creation of the clone caused the snapshot tree to have a clone depth that exceeds the threshold.

11. The medium of claim 8, including instructions to:
maintain a clone table that associates each of a plurality of clones in the snapshot tree with a respective clone depth identifier; and
determine that the snapshot tree exceeds the threshold based on a value of the respective clone depth identifier associated with the clone exceeding the threshold.

12. The medium of claim 8, wherein the instructions to determine that the snapshot tree exceeds the threshold comprise instructions to:
count read requests associated with the clone that cause ascension through the diskchain in order to satisfy the read requests; and
determine that the count exceeds the threshold.

13. The medium of claim 8, wherein the instructions to create the consolidated snapshot include instructions to:
issue a read request for a current logical address and a number of addresses corresponding to the VCI;
receive, responsive to the read request, a logical-to-physical address mapping associated with the VCI, wherein the logical-to-physical address mapping includes tuples from the diskchain of the clone in the snapshot tree; and
append the consolidated snapshot to the logical-to-physical address mapping.

14. The medium of claim 8, including instructions to:
receive a read request for a logical address corresponding to the VCI after the creation of the consolidated snapshot; and
search the consolidated snapshot for a tuple corresponding to the logical address responsive to a determination that the logical address is not in any snapshots of a snapshot chain of the clone.

15. A system, comprising:
a clone engine configured to create a clone of a virtual computing instance (VCI) in a snapshot tree provided by a software defined data center; and
a consolidated snapshot engine configured to create a consolidated snapshot including tuples from a diskchain of the clone in the snapshot tree responsive to a determination that the snapshot tree exceeds a threshold.

16. The system of claim 15, wherein the consolidated snapshot engine is configured to create the consolidated snapshot including all tuples from the diskchain of the clone in the snapshot tree.

17. The system of claim 15, wherein the consolidated snapshot engine is configured to determine that the creation of the clone caused the snapshot tree to have a clone depth that exceeds the threshold.

18. The system of claim 15, wherein the consolidated snapshot engine is configured to:
count read requests associated with the clone that cause ascension through the diskchain in order to satisfy the read requests; and
determine that the count exceeds the threshold.

19. The system of claim 15, wherein the consolidated snapshot engine is configured to:
issue a read request for a current logical address and a number of addresses corresponding to the VCI;
receive, responsive to the read request, a logical-to-physical address mapping associated with the VCI, wherein the logical-to-physical address mapping includes tuples from the diskchain of the clone in the snapshot tree; and
append the consolidated snapshot to the logical-to-physical address mapping.

20. The system of claim 15, including a read engine configured to:
receive a read request for a logical address corresponding to the VCI after the creation of the consolidated snapshot; and
search the consolidated snapshot for a tuple corresponding to the logical address responsive to a determination that the logical address is not in any snapshots of a snapshot chain of the clone.
